(19) United States
(12) Patent Application Publication
(10) Pub. No.: US 2004/0201999 A1
(43) Pub. Date: Oct. 14, 2004

(54) Stand lamp with horizontally rotatable lamp units

(75) Inventor: Ching Yueh, Taipei City (TW)

Correspondence Address: BACON & THOMAS, PLLC, 625 SLATERS LANE, FOURTH FLOOR, ALEXANDRIA, VA, 22314

(73) Assignee: Test Rite International Company, LTD., Taipei City (TW)

(21) Appl. No.: 10/765,151

(22) Filed: Jan. 28, 2004

(30) Foreign Application Priority Data
Jan. 29, 2003 (CN) 03201448.1

(51) Int. Cl. F21S 8/08

(52) U.S. Cl. 362/410

(57) ABSTRACT

A lamp having horizontally rotatable lamp units comprising a lamp stand, a lamp pole disposed on the lamp stand and at least one lamp unit disposed on the lamp pole. The lamp unit is fixated on the lamp pole by fastening members extending into the corresponding horizontal grooves disposed on the lamp pole so as to enable the lamp unit to rotate horizontally.

### BACKGROUND OF THE INVENTION

1. Field of the Invention

The present invention relates to a lamp having horizontally rotatable lamp units so as to adjust the horizontal illuminating range of the lamp units.

2. Description of the Related Art

Common lamp units of lamps are fixated via screws on vertical lamp poles, with such lamp poles further fastened on lamp stands, which could be floor lamps or desk lamps.

Such design of fixating lamp units renders the lamp units unable to rotate horizontally, such that the need to illuminate horizontally cannot be satisfied thereby, unless the user move and rotate the whole lamps. Therefore, such inconvenience calls for further improvements.

### SUMMARY OF THE INVENTION

The object of the present invention is to provide a lamp having horizontally rotatable lamp units, which are fixated on the lamp pole with fastening members so as to allow the lamp units to rotate on the lamp pole, thus effectively enlarging the illuminating range and achieving the effect of illumination.

The lamp having horizontally rotatable lamp units that is capable of achieving the foregoing object comprises a lamp stand, a lamp pole vertically disposed on the lamp stand and extending upwards, and at least one lamp unit disposed on the outer portion of the lamp pole via a wrapping tube disposed therewith, characterized in that, the lamp pole is disposed with at least one horizontal groove, and a fastening member is fastened in the wrapping tube of the lamp unit so as to fixate the lamp unit on the lamp stand; the fastening member extends into the corresponding groove on the lamp pole so as to enable the lamp unit to rotate horizontally following the displacement of the fastening member in the groove.

The fastening member is an inner hex screw.

The lamp is a floor lamp or a desk lamp.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 shows a block diagram of the lamp having horizontally rotatable lamp units of the present invention;

FIG. 2 shows a partial sectional view from the side of the lamp having horizontally rotatable lamp units of the present invention;

FIG. 3 shows a sectional view of the Line X-X in FIG. 1; and

FIG. 4 shows a top plan motional view of the lamp having horizontally rotatable lamp units of the present invention.

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

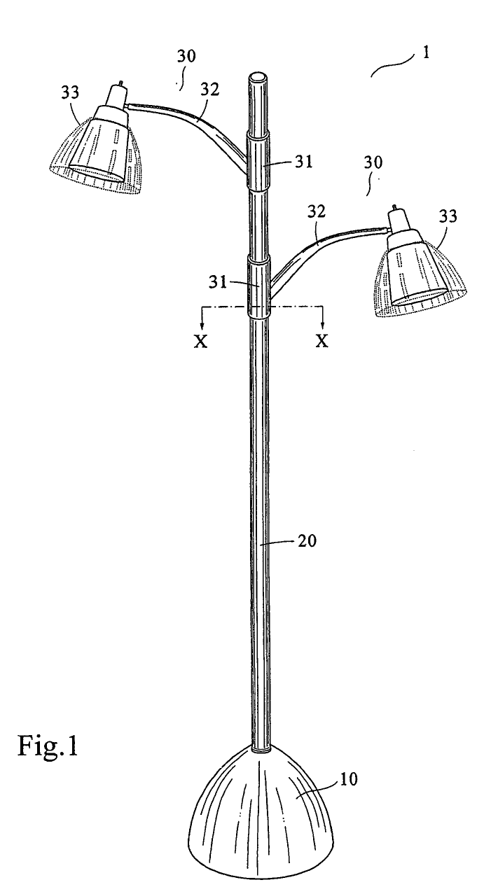

Please refer to FIG. 1, which shows a block diagram of the lamp 1 having horizontally rotatable lamp units of the present invention, comprising a lamp stand 10 with the shape thereof being, for example, conical, a lamp pole 20 vertically disposed on the lamp stand 10 and extending upwards, lamp units 30 disposed in different directions on the outer portion of the lamp pole 20 with a wrapping tube 31 respectively wrapping around the lamp pole 10. The wrapping tube 31 connects with the lamp cover 33 by a support 32.

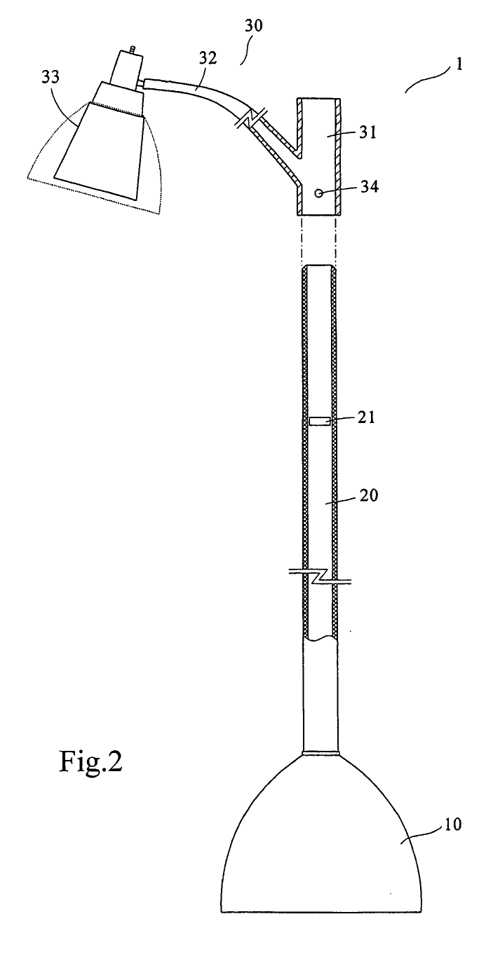

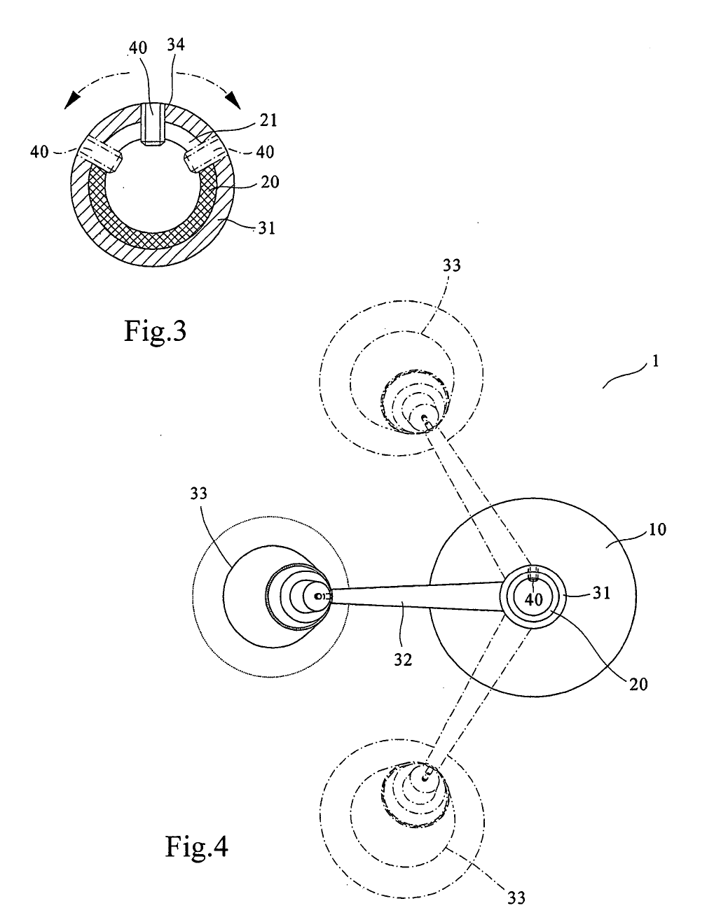

Please refer to FIG. 2, with only one lamp unit 30 being shown for more convenient elaboration. The wrapping tube 31, having a screw hole 34, of the lamp unit 30 wraps around the outer portion of the lamp pole 20, which has a horizontal groove 21 for corresponding to the screw hole 34. Please also refer to FIG. 3, wherein a fastening member 40, for example, an inner hex screw, is fastened into the screw hole 34 of the wrapping tube 31 and extends into the groove 21 of the lamp pole 20.

As shown in FIG. 3 and FIG. 4, the lamp unit 30 is positioned on the lamp pole 20 because the wrapping tube 31 wraps around the lamp pole 20 and then the fastening member 40 fixates the wrapping tube 31 on the lamp pole 20. Further, since the fastening member 40 fixates the wrapping tube 31 on the lamp pole 20 and extends into the groove 21 of the lamp pole 20, the lamp unit 30 can bring the fastening member 40 to displacement in the groove 21 with the fastening member 40 used as a member to limit the angles of displacement. Thus the lamp unit 30 would rotate horizontally with respect to the lamp pole 20, so as to provide the different needs for horizontal illumination.

The conventional technologies, including the lamp pole and support are both hollow with wires concealed therein, switches are disposed on the lamp cover so as to turn on and off of the light bulb inside the lamp cover, and the lamp stand can be of any shape, employed by the present invention, are not to be elaborated herein.

Although the present invention has been described in considerable detail with reference to certain preferred embodiments thereof, those skilled in the art can easily understand that all kinds of alterations and changes can be made within the spirit and scope of the appended claims. For example, the lamp of the present invention can be a floor lamp or a desk lamp, the fastening member of the present invention is an inner hex screw so as not to protrude out of the outer surface of the lamp pole for avoiding any adverse effect on the appearance thereof, the connecting portion between the lamp cover of the lamp unit and the support can be freely adjusted with the conventional design of using the connecting portion as a pivot, and the number of lamp units of the present invention should be at least one and the lamp units shall be disposed at different heights on the lamp pole. Therefore, the spirit and scope of the appended claims should not be limited to the description of the preferred embodiments contained herein.

What is claimed is:

1. A lamp having horizontally rotatable lamp units, comprising:
a lamp stand;
a lamp pole vertically disposed on said lamp stand and extending upwards; and
at least one lamp unit disposed on the outer portion of said lamp pole via a wrapping tube disposed therewith;
characterized in that, said lamp pole being disposed with at least one horizontal groove, a fastening member being fastened in said wrapping tube of said lamp unit so as to fixate said lamp unit on said lamp stand, said fastening member extending into said corresponding groove on said lamp pole so as to enable said lamp unit to rotate horizontally with respect to the displacement of said fastening member in said groove.

2. The lamp having horizontally rotatable lamp units as in claim 1, wherein
said fastening member is an inner hex screw.

3. The lamp having horizontally rotatable lamp units as in claim 1, wherein
said lamp is a floor lamp or a desk lamp.
